(19) United States
(12) Patent Application Publication
(10) Pub. No.: US 2024/0398155 A1
(43) Pub. Date: Dec. 5, 2024

(54) Brewing Component of Coffee Machine

(71) Applicants: Richard HUANG, Taoyuan (TW); Li-Min LI, Taoyuang (TW)

(72) Inventors: Richard HUANG, Taoyuan (TW); Li-Min LI, Taoyuan (TW)

(21) Appl. No.: 18/731,286

(22) Filed: Jun. 1, 2024

(30) Foreign Application Priority Data
Jun. 2, 2023 (TW) 112120773
Jun. 6, 2023 (TW) 112205728

(51) Int. Cl. A47J 31/46

(52) U.S. Cl. CPC A47J 31/46

(57) ABSTRACT

A brewing component of coffee machine includes an upper cover with a plurality of water inlet holes, each receives hot water through a single water supply path and penetrates the upper and lower surfaces of the upper cover, and a base is placed under the upper cover and combined with the upper cover. The upper surface of the base has a plurality of annular areas separated by concentric grooves of different diameters, each has a plurality of water injection holes uniformly distributed along the circumferential direction, and separates the annular area to form a plurality of watertight areas through the O-rings. Hot water is guided to the watertight areas through the plurality of water inlet holes for brewing ground coffee, where the plurality of watertight areas provides one-time water injection or sectional water injection.

### TECHNICAL FIELD

The present invention relates to a coffee machine, specifically a brewing component of the coffee machine.

### BACKGROUND

Coffee is an extremely popular beverage in today's society. Since the modem life is fast-pace and under high pressure, the coffee may boost spirit and reduce drowsiness by stimulating the central nervous system. Therefore, the coffee has become one of the necessity matters for people to refresh themselves, and the coffee market has grown rapidly to meet the demands.

Hand-brewed coffee involves a step to inject water into the coffee powder through a filter paper. When making the coffee, the users hold the hand-brewed kettle, slowly and spirally pour hot water into the coffee powder from inner to outer area with appropriate water flow, such that the coffee powder is brewed evenly by the hot water. The coffee drips through the filter paper. The flavor of the brewed coffee is related to individual experience if the coffee is made by manual brewing, thus, the coffee flavor is difficult to maintain consistency.

Existing automatic coffee machines employ automatic processes to grind coffee beans into coffee powder, followed by flowing the hot water through the coffee powder to extract coffee liquid. Alternatively, the coffee powder is placed in a typical coffee machine funnel with a filter (such as filter paper), and the hot water is subsequently injected to extract the coffee liquid.

The coffee machine is generally designed to have a single water outlet, or it is designed with a sprinkler having multiple outlets. However, these water outlet designs only consider the control of water outlet volume, and fail to consider the water outlet method and style. Therefore, although the coffee machines that follow this type of spout design and controlling method provide fast and easy-to-extract coffee, it is unlikely to imitate the manual brewing style and achieve the best flavor of the coffee.

Based on the prior art shortcomings, the present invention improves the brewing component of the coffee machines to imitate the brewing method of hand-brewed coffee by improving the water outlet component design and the control of the water outlet method.

### SUMMARY OF THE INVENTION

In order to achieve above purpose, the present invention provides a brewing component of a coffee machine having an upper cover with pluralities of water inlet holes, each the water inlet holes receives the hot water from a respective hot water supply path and penetrates the upper surface and the lower surface of the upper cover; a base is placed under the upper cover and engages the upper base, wherein the upper surface of the base includes pluralities of annular areas separated by pluralities of concentric grooves of different diameters, each annular areas includes water injection holes distributed along a circumferential direction, wherein pluralities of watertight areas are formed by separating the annular areas by O-rings set on the pluralities of the concentric grooves of the different diameters; wherein the hot water guided from the pluralities of the water inlet holes to the pluralities of watertight areas is used to brew coffee power under the pluralities of watertight areas by injecting water to the pluralities of the water inlet holes corresponding to the pluralities of watertight areas; wherein the pluralities of watertight areas provide one-time water injection or sectional water injection.

In one embodiment, the upper cover includes pluralities of circular grooves with a common center on the lower surface of the upper cover, the pluralities of circular grooves are configured to align to the pluralities of water inlet holes to constrain the flow of the hot water to the pluralities of watertight areas.

In one embodiment, the pluralities of water inlet holes are arranged extending outward from the center of the upper cover.

In one embodiment, each pluralities of water inlet holes respectively controls a water flow switch and flowing rate by a solenoid valve and a throttle valve.

In one embodiment, the pluralities of watertight areas provide on-time water injection or sectional water injection method through a control unit to control the solenoid valve corresponding to the pluralities of water inlet holes and to manually adjust the throttle valve.

In one embodiment, wherein the sectional water injection is controlled by the control unit from a center area to an outer edge in a manner of time sequence for imitating water filling actions of hand-brewed coffee.

In one embodiment, wherein the control unit is a microcontroller, a microprocessor, or a programmable logic controller (PLC).

In one embodiment, the pluralities of water inlet holes provide water through pluralities of water supply paths provided by a distributor.

In one embodiment, an inlet end of the distributor is connected to a water supply unit by a solenoid valve to open or close a water supply from the water supply unit.

In one embodiment, the water supply unit provides the hot water.

### BRIEF DESCRIPTION OF THE DRAWINGS

FIG. 1 illustrates a schematic diagram of a coffee machine system corresponding to a coffee machine brewing component according to the present invention.

FIG. 2 shows a three-dimensional view of a coffee machine brewing component according to the present invention.

FIG. 3 shows three views of an upper cover of a coffee machine brewing component according to the present invention.

FIG. 4 shows three views of a base of a coffee machine brewing component according to the present invention.

FIG. 5 shows a top view and a cross-sectional view of a brewing component after the combination according to the present invention.

### DETAILED DESCRIPTION

Here, the present invention is described in detail with respect to specific embodiments and viewpoints of the present invention. This description is used to explain the structure or step process of the present invention, which is for illustration purposes rather than limiting the scope of the present invention. Therefore, in addition to the specific embodiments and preferred embodiments in the specification, the present invention can also be widely implemented in other different embodiments. The following describes the implementation of the present invention through specific embodiments. A person having ordinary skill in the art can easily understand the efficacy and advantages of the present invention through the content disclosed in this specification. Moreover, the present invention can also be used and implemented through other specific embodiments. Various details described in this specification can also be applied based on different needs, and various modifications or changes can be made without departing from the spirit of the present invention.

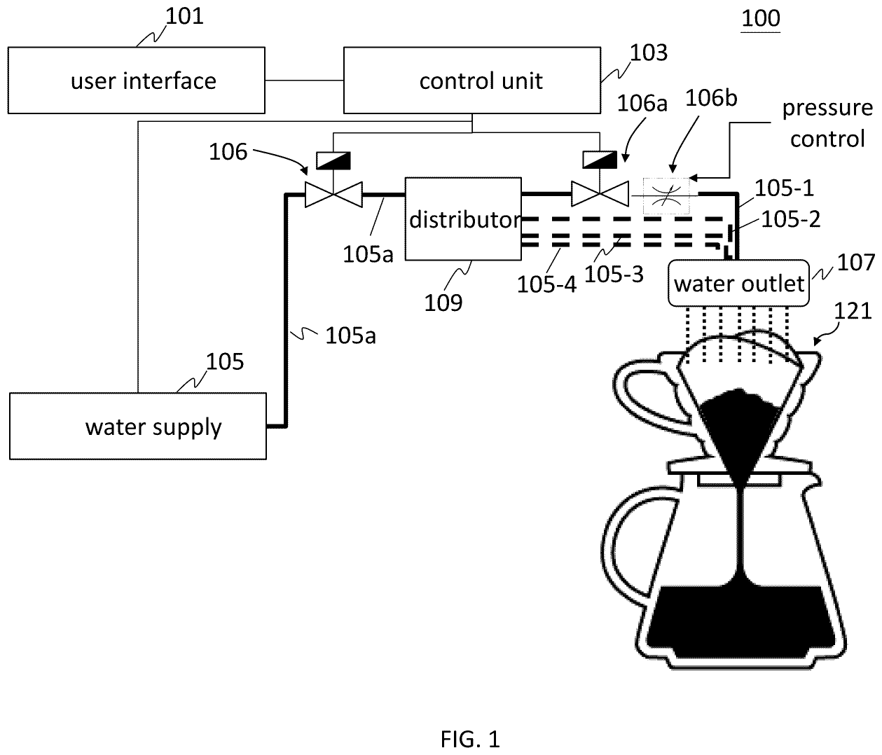

FIG. 1 shows a schematic diagram of a coffee machine system 100, which at least includes a user interface 101, a control unit 103, a water supply 105 and a water outlet 107. The water supply 105 provides hot water to the water outlet 107 through a water supply pipeline 105a for brewing coffee placed in the coffee powder tank 121. The coffee machine system 100 further includes a distributor 109 connected to the water supply pipeline 105a, the water inlet of the distributor 109 is coupled to a water inlet solenoid valve 106 for opening or closing the water from the water supply 105, the distributor 109 has pluralities of water outlets, each water outlet is set with a solenoid valve 106a and a throttle valve 106b, and the downstream of the throttle valve 106b is connected to the water outlet 107. The water outlets 107 provide water supply paths (105-1, 105-2, 105-3, 105-4) connected to the water outlets 107. The water outlet distribution and water output volume of the water outlet 107 is controlled by the control unit 103 which control the solenoid valves (106, 106a) set at the water inlet end and water outlet end of the distributor 109, in addition to adjusting the throttle valve 106b of each water outlet. The user interface 101 is connected to the control unit 103, and the user control the water distribution and water output volume through the user interface 101 to achieve different water outlet modes when brewing coffee (described in detail later).

According to an embodiment of the present invention, the control unit 103 may be a microcontroller, a microprocessor, a programmable logic controller (PLC), other similar components or any combination thereof.

According to an embodiment of the present invention, the distributor 109 is a multi-channel water flow distributor made of stainless steel, the distributor 109 is used to branch the water flow from one channel to multiple outputs.

According to an embodiment of the present invention, the user interface 101 may be a touch display panel or a combination of a display panel and control buttons.

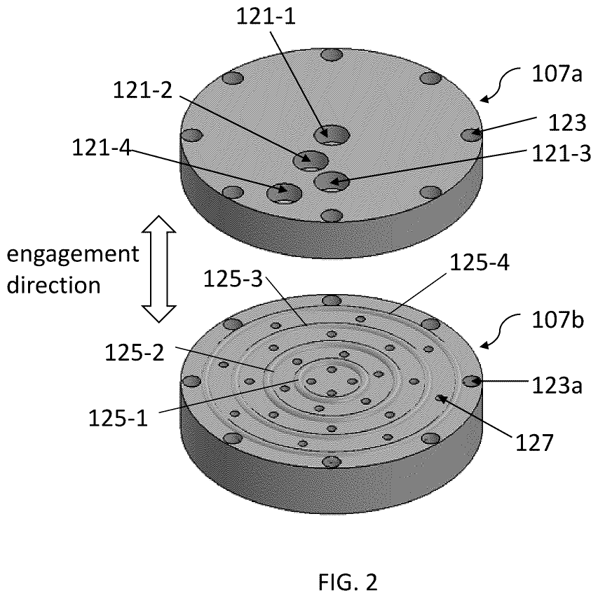

FIG. 2 shows the brewing component of the coffee machine according to the present invention, namely, the 3D diagram of the water outlet 107 in FIG. 1. FIG. 2 shows the separated 3D view of the brewing component 1071 before assembly. The engagement direction is indicated in FIG. 2. The brewing component 1071 includes an upper cover 107a and a base 107b. The upper cover 107a of the brewing component 1071 has water inlets (121-1, 121-2, 121-3, 121-4) that are respectively connected to the water supply paths (105-1, 105-2, 105-3, 105-4) branched from the distributor 109 (refer to FIG. 1). The base 107b is provided below the upper cover 107a. The upper cover 107a and the base 107b are engaged and fixed by screws with screw holes 123, 123a set on the outer edges of the upper cover 107a and the base 107b. The surface of the upper cover 107a facing the base 107b has a plurality of concentric grooves (not shown) for setting a plurality of corresponding O-rings (125-1, 125-2, 125-3, 125-4) to form a central watertight area and pluralities of annular watertight areas when the base 107b is assembled with the upper cover 107a. Each annular watertight areas is provided with pluralities of water injection holes 127 penetrating the upper and lower surfaces of the base 107b, and the water injection holes 127 in individual annular watertight areas are evenly distributed along the circumferential direction of the annular area.

According to the embodiment of the present invention, the upper cover 107a has a plurality of water inlets (121-1, 121-2, 121-3, 121-4) set thereon, all of which are through holes penetrating the upper and lower surfaces of the upper cover 107a and the through holes are connected to the water supply paths (105-1, 105-2, 105-3, 105-4) branched from the distributor 109 through water pipes adapter. The water inlets (121-1, 121-2, 121-3, 121-4) are radially set outward from the center of the upper cover 107a, and are correspond to the first watertight area (or the central watertight area) surrounded by the O-ring 125-1, the second watertight area surrounded by the O-ring 125-1 and the O-ring 125-2, and the third watertight area surrounded by the O-ring 125-2 and the O-ring 125-3, and the fourth watertight area surrounded by the O-ring 125-3 and the O-ring 125-4.

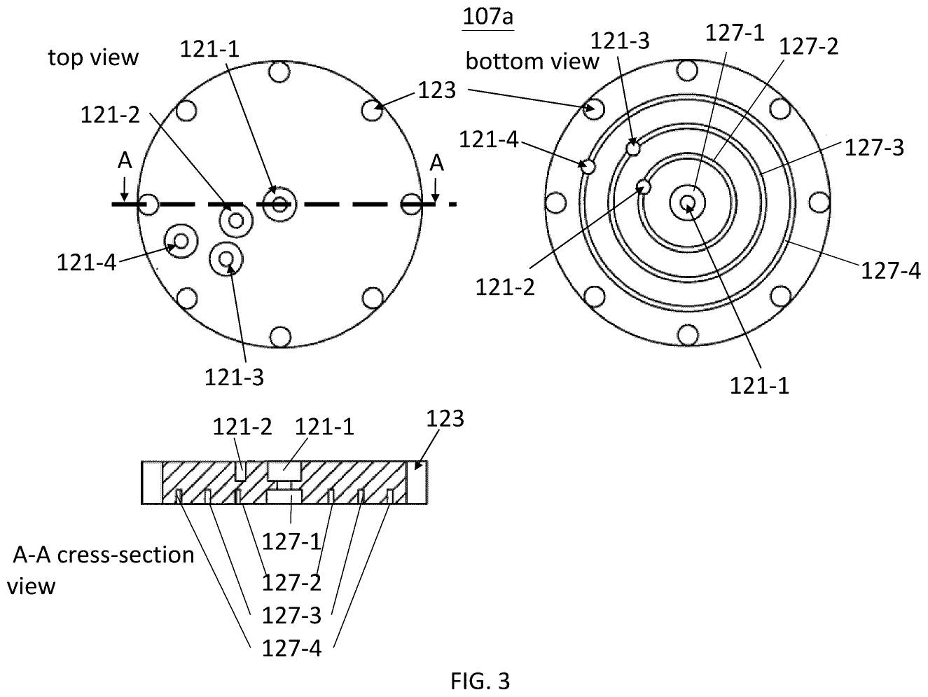

In order to describe the upper cover 107a of the brewing component in more detail, FIG. 3 shows three views of the upper cover 107a including the top view, the bottom view and the cross-section view along the A-A direction. It can be seen from the bottom view of the upper cover 107a, the lower surface of the upper cover 107a includes the central circular groove 127-1, the first annular groove 127-2, the second annular groove 127-3 and the third annular groove 127-4. Wherein the central circular groove 127-1, the first annular groove 127-2, the second annular groove 127-3 and the third annular groove 127-4 have a common center.

According to the embodiment of the present invention, the water inlets (121-1, 121-2, 121-3, 121-4) set on the upper cover 107a are respectively corresponding to the central circular grooves 127-1, the first annular groove 127-2, the second annular groove 127-3 and the third annular groove 127-4 and penetrate through the lower surface of the upper cover 107a to form corresponding pluralities of through holes.

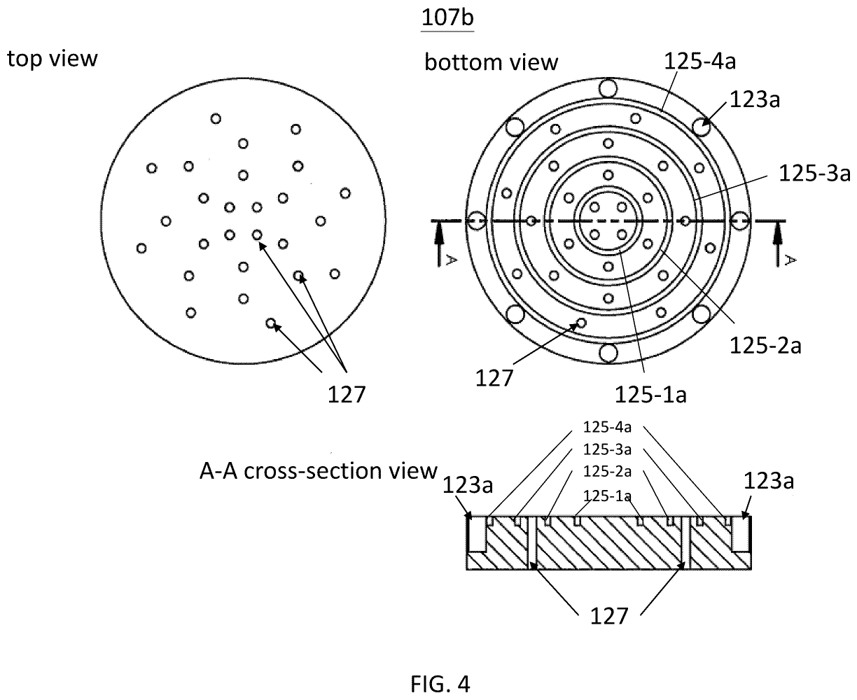

FIG. 4 shows three views of the base 107b, including the top view, the bottom view and the cross-sectional view along the A-A direction. The top view shows a plurality of concentric circular grooves (125-1a, 125-2a, 125-3a, 125-4a) for locating the O-rings (125-1 [symbol] 125-2 [symbol] 125-3 [symbol] 125-4) as described in FIG. 2.

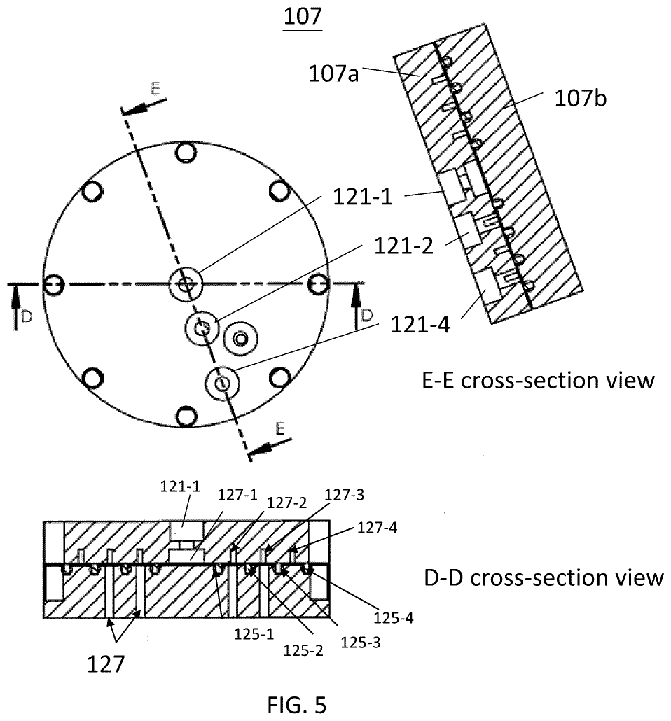

FIG. 5 shows the top view and the cross-sectional view of the brewing component after assembly according to the present invention. Through the top view and the cross-sectional view along the D-D and E-E directions, they clearly show that after the combination of the upper cover 107a and the base 107b, the water inlets (121-1, 121-2, 121-3. 121-4) set on the upper cover 107a are respectively corresponding with the central circular groove 127-1, the first annular groove 127-2, the second annular groove 127-3 and the third annular groove 127-4, which are aligned with the first watertight area (or central watertight area) surrounded by the O-ring 125-1, the second watertight area surrounded by the O-ring 125-1 and the O-ring 125-2, the third watertight area surrounded by the O-ring 125-2 and the O-ring 125-3, the fourth watertight area surrounded by the O-ring 125-3 and the O-ring 125-4.

The present invention controls the coffee machine's brewing component to inject water by one time or sectionally, and individually control the water injection flow rate in different individual areas through a plurality of solenoid valves controlled by the control unit 103 and the manual adjustable throttle valve. Wherein the sectional water injection can be controlled by the controller, the water is poured from the center area to the outer edge in a manner of time sequence for simulating the water filling action of hand-brewed coffee. According to the embodiment of the present invention, the individual sectional water injection areas refer to the watertight areas mentioned in the previous paragraph.

The design of the brewing component proposed by the present invention can provide flow restriction of hot water that flows through a plurality of water inlets (121-1, 121-2, 121-3, 121-4) to flow through the corresponding central circular groove 127-1, the first annular groove 127-2, the second annular groove 127-3 and the third annular groove 127-4 disposed on the lower surface of the upper cover and can guide the hot water to a plurality of water injection holes 127 provided in individual annular watertight areas for brewing coffee powder located below them.

While above embodiments of the present invention have been described, those skilled in the art should understand that the embodiments are used to illustrate the present invention, and not limitations. The scope of the present invention should be defined by the accompanying claims and their equivalent. Any changes or modifications made by the person skilled in the art without departing from the spirit or scope of the present invention shall be deemed as equivalent changes or designs within the scope of the present invention, and shall be included in the following claims.

What is claimed is:

1. A brewing component of a coffee machine, comprising:
an upper cover with pluralities of water inlet holes, each said pluralities of water inlet holes receiving hot water from a respective hot water supply path and penetrating an upper surface and a lower surface of said upper cover;
a base placed under said upper cover and engaging said upper base, wherein an upper surface of said base having pluralities of annular areas separated by pluralities of concentric grooves of different diameters, each said pluralities of annular areas having water injection holes distributed along a circumferential direction, wherein pluralities of watertight areas are formed by separating said annular areas by O-rings set on said pluralities of said concentric grooves of said different diameters;
wherein said hot water guided from said pluralities of said water inlet holes to said pluralities of watertight areas is used to brew coffee power under said pluralities of watertight areas by injecting water to said pluralities of water inlet holes corresponding to said pluralities of watertight areas;
wherein said pluralities of watertight areas provide one-time water injection or sectional water injection.

2. The brewing component of claim 1, wherein said upper cover includes pluralities of circular grooves with a common center on said lower surface of said upper cover, said pluralities of circular grooves being configured to align to said pluralities of water inlet holes to constrain the flow of said hot water to said pluralities of watertight areas.

3. The brewing component of claim 2, wherein said pluralities of water inlet holes are arranged extending outward from a center of said upper cover.

4. The brewing component of claim 1, wherein each said pluralities of water inlet holes respectively controls a water flow switch and a flowing rate by a solenoid valve and a throttle valve.

5. The brewing component of claim 4, wherein said pluralities of watertight areas provide said one-time water injection or said sectional water injection method through a control unit to control said solenoid valve corresponding to said pluralities of water inlet holes and manually adjusting said throttle valve.

6. The brewing component of claim 5, wherein said sectional water injection is controlled by said control unit from a center area to an outer edge in a manner of time sequence for imitating a water filling action of hand-brewed coffee.

7. The brewing component of claim 5, wherein said control unit is a microcontroller, a microprocessor, or a programmable logic controller (PLC).

8. The brewing component of claim 1, wherein said pluralities of water inlet holes provide water through pluralities of water supply path provided by a distributor.

9. The brewing component of claim 1. wherein an inlet end of said distributor is connected to a water supply unit by a solenoid valve to open or close a water supply from said water supply unit.

10. The brewing component of claim 1. wherein said water supply unit provides said hot water.
